(19) United States
(12) Patent Application Publication
(10) Pub. No.: US 2003/0142228 A1
(43) Pub. Date: Jul. 31, 2003

(54) Apparatus and method for power saving and rapid response in a digital imaging device

(76) Inventors: Matthew Flach, Fort Collins, CO (US); Heather N. Bean, Fort Collins, CA (US); Miles K. Thorland, Fort Collins, CA (US)

Correspondence Address: HEWLETT-PACKARD COMPANY, Intellectual Property Administration, P.O. Box 272400, Fort Collins, CO, 80527-2400, US

(21) Appl. No.: 10/057,614

(22) Filed: Jan. 25, 2002

(51) Int. Cl. H04N 5/225

(52) U.S. Cl. 348/335; 348/372

(57) ABSTRACT

A digital imaging device having a retractable lens may be turned off or on with the lens in the extended position, thereby saving battery power and facilitating rapid response to picture taking opportunities. The power saving and rapid response mode may be activated via a menu option, a predetermined gesture involving the power button, an alternative control element, or other suitable means.

### FIELD OF THE INVENTION

The present invention relates generally to battery-operated digital imaging devices and more specifically to techniques for conserving power and reducing start-up delay in such devices.

### BACKGROUND OF THE INVENTION

Many digital imaging devices such as digital still cameras and digital video cameras include a retractable lens that is extended automatically whenever the device is powered up and retracted whenever the device is shut down. Since many photographers cycle the power of a digital camera or camcorder as often as several times per hour when the device is in use, significant battery charge may be wasted due to the repeated extension and retraction of the lens. Also, digital photographers sometimes miss important picture taking opportunities because they must wait up to five seconds for the lens to be extended after they turn on the device. It is thus apparent that there is a need in the art for an improved apparatus and method for power saving and rapid response in a digital imaging device having a retractable lens.

### SUMMARY OF THE INVENTION

A digital imaging device is provided comprising a retractable lens and control logic configured to toggle the power-on status of the device while the lens is in the extended position. An associated method is also provided.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is an illustration of a digital camera with a retractable lens in accordance with an illustrative embodiment of the invention.

FIG. 2 is a block diagram of the digital camera shown in FIG. 1 in accordance with an illustrative embodiment of the invention.

FIG. 3 is a flowchart of a method of operation of the digital camera shown in FIGS. 1 and 2 in accordance with an illustrative embodiment of the invention.

FIG. 4 is a flowchart of a method of operation of the digital camera shown in FIGS. 1 and 2 in accordance with another illustrative embodiment of the invention.

### DETAILED DESCRIPTION OF THE INVENTION

Both extension of battery life and the ability to respond quickly to picture taking opportunities are facilitated if the digital imaging device may be turned on or off while the lens is extended. First, being able to turn the device off with the lens extended extends battery life by reducing the number of extensions and retractions. Secondly, leaving the lens extended when the device is turned off eliminates the delay incurred by extending the lens when the device is again powered up, allowing the photographer to respond more rapidly to picture taking opportunities.

Although the invention will be described in the context of a digital still camera, this is merely an illustrative embodiment to explain the principles and operation of the invention. The present invention is applicable to any digital imaging device employing a retractable lens. Examples include but are not limited to digital still cameras and digital video cameras, often called “digital camcorders.”

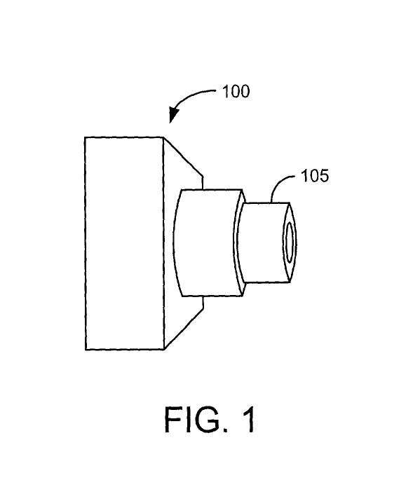

FIG. 1 is an illustration of a digital camera 100 in accordance with an illustrative embodiment of the invention. Digital camera 100 includes a retractable lens 105. Retractable lens 105 may occupy a retracted position or an extended position.

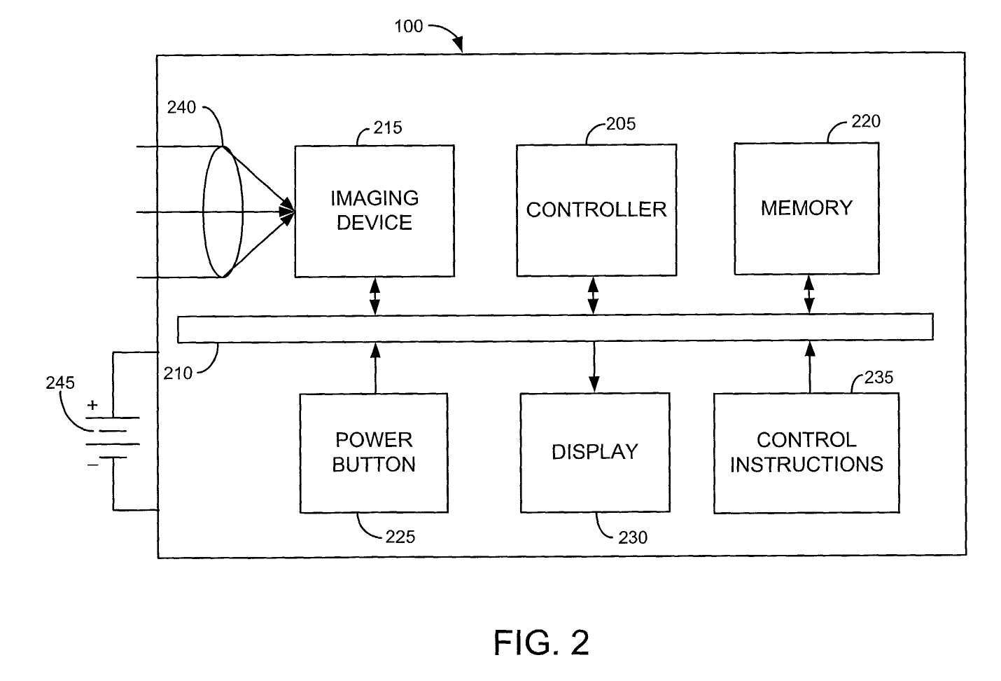

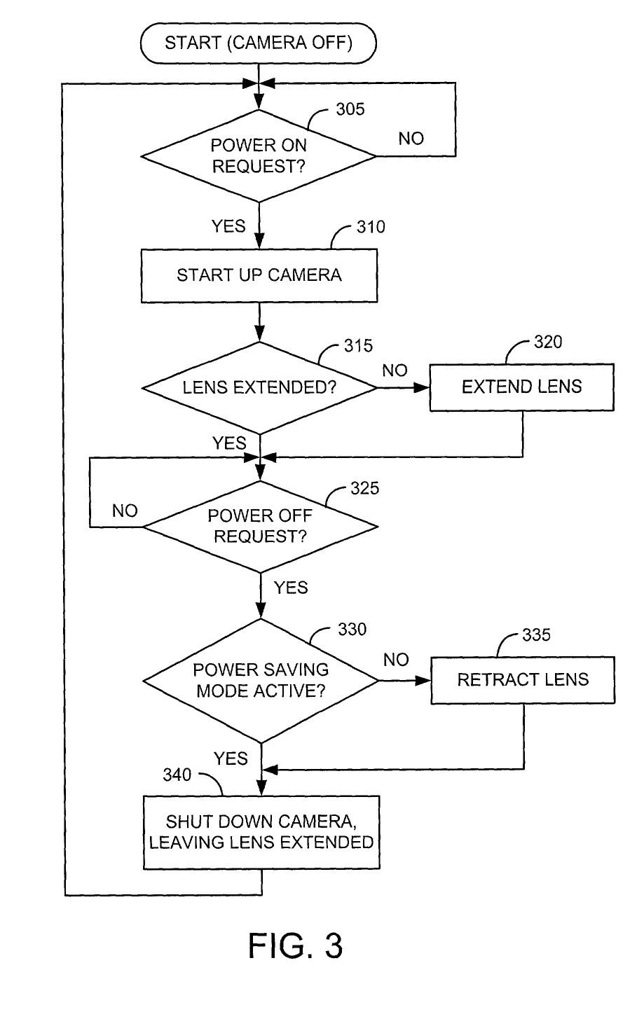

FIG. 2 is a block diagram of digital camera 100 in accordance with an illustrative embodiment of the invention. In FIG. 2, controller 205 communicates over data bus 210 with imaging device 215, memory 220, power button 225, and display 230 in accordance with control instructions 235. Typically, controller 205 is a microprocessor or microcontroller, and control instructions 235 are stored program code. Alternatively, controller 205 and control instructions 235 may be implemented in hardware as an application-specific integrated circuit (ASIC). Imaging device 215 converts optical images received from optical system 240, of which retractable lens 105 is a part, to digital images. In a typical implementation, imaging device 215 comprises a charge-coupled device (CCD), an analog-to-digital converter (A/D), a gain control, and a digital signal processor (DSP) (not shown in FIG. 2). Memory 220 may comprise internal RAM, internal non-volatile memory such as flash memory, and external non-volatile memory, typically of the removable type. Digital camera 100 may be powered by battery 245 and may include other input controls in addition to power button 225. Control instructions 235 may be configured to allow digital camera 100 to be turned off while retractable lens 105 is in the extended position. Conversely, control instructions 235 may also be configured to allow digital camera 100 to be turned on with retractable lens 105 in the extended position. Hereinafter, the state of digital camera 100 being powered on or off will be referred to as its “power-on status.” Thus, control instructions 235 may be configured to toggle the power-on status of digital camera 100 while retractable lens 105 is in the extended position. Methods by which a photographer may control whether or not retractable lens 105 is allowed to remain extended at power down will be described in connection with FIG. 3.

FIG. 3 is a flowchart of the operation of digital camera 100 in accordance with an illustrative embodiment of the invention. As the diagram of FIG. 3 is entered, the power-on status of digital camera 100 is assumed to be “off.” At 305, a request to toggle the power-on status of digital camera 100 causes controller 205 to start up the device at 310. As part of the start-up process, controller 205 may check the position of retractable lens 105 at 315. If retractable lens 105 is not extended, it may be extended at 320. Otherwise, control proceeds to 325. If another request to toggle the power-on status of digital camera 100 (to “off”) is received at 325, control proceeds to 330. At 330, controller 205 determines whether a power saving and rapid response mode (“power saving mode”) is active in digital camera 100. If not, retractable lens 105 is retracted at 335, digital camera 100 is shut down at 340, and control returns to 305. If the power saving mode is active at 330, digital camera 100 is shut down at 340 without retractable lens 105 being retracted, and control returns to 305.

The power saving mode may be activated in a variety of ways. Four examples include the following. First, the power saving mode may be activated as a menu option in the device's software or firmware. When this mode is active, a normal press of the power button shuts down the device without retracting retractable lens 105. Secondly, power button 225 may be pressed and held for a predetermined period (e.g., 2-3 seconds) to differentiate a shut down in which retractable lens 105 is left extended from a normal shut down in which retractable lens 105 is retracted. Thirdly, a separate button or any other hardware or software control element may be used to turn off digital camera 100 without retracting retractable lens 105. Fourthly, the power saving mode may be activated automatically in response to a signal from a timer. After a predetermined period of inactivity in the “on” state with retractable lens 105 extended, digital camera 100 may be shut down without retractable lens 105 being retracted. This technique may further extend the life of battery 245. Subsequently powering up digital camera 100 with retractable lens 105 extended may be performed in response to a normal momentary press of power button 225 or by activation of an alternative button or any other hardware or software control element.

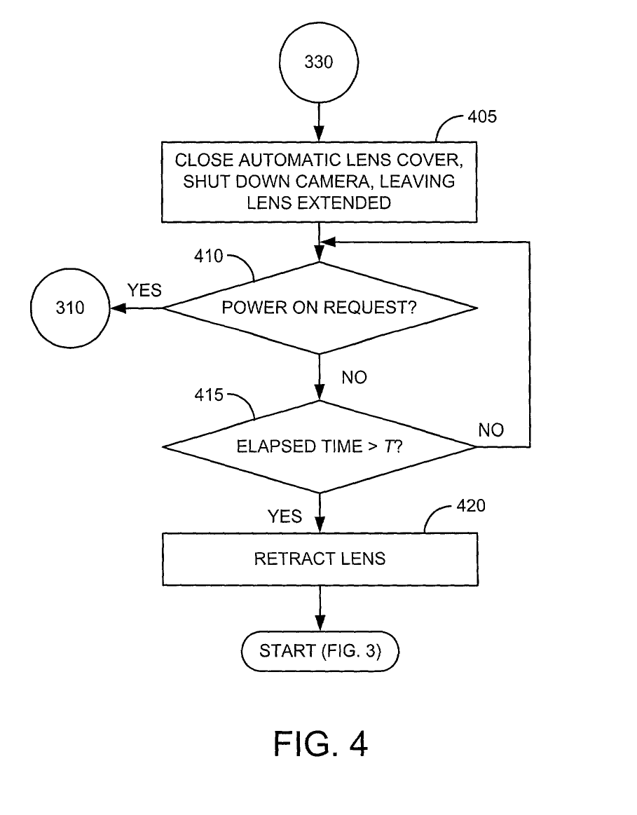

FIG. 4 is a flowchart of the operation of digital camera 100 in accordance with another illustrative embodiment of the invention. In this embodiment, additional steps, either separately or in combination, may be added to the method shown in FIG. 3. Once it has been determined at 330 in FIG. 3 that the power saving mode is active, control may proceed to 405 in FIG. 4. At 405, the automatic lens cover of digital camera 100, sometimes informally called the “lens wink,” may be closed to protect retractable lens 105 from dust and moisture. Also, digital camera 100 may be shut down without retracting retractable lens 105. If a power-on request is received at 410, control proceeds to 310 in FIG. 3. Otherwise, control proceeds to 415. At 415, the elapsed time since digital camera 100 was shut down with retractable lens 105 extended at 405 is compared to a predetermined period T. If the period T is exceeded, retractable lens 105 is automatically retracted at 420. Control may then return to “Start” in FIG. 3. Time out period T may be configured by the photographer or preset by the manufacturer.

In yet another embodiment, the power saving mode may be designated as the default mode of operation for digital camera 100. In this embodiment, a predetermined gesture from the photographer such as pressing and holding the power button or activating an alternative hardware or software control element may be used to retract lens 105 at or following shut down.

The foregoing description of the present invention has been presented for the purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A digital imaging device, comprising:
a lens having an extended position and a retracted position; and
control logic configured to toggle the power-on status of the digital imaging device without retracting the lens, when the lens is in the extended position.

2. The digital imaging device of claim 1, wherein the digital imaging device comprises a digital still camera.

3. The digital imaging device of claim 1, wherein the digital imaging device comprises a digital camcorder.

4. The digital imaging device of claim 1, wherein the control logic is configured to toggle the power-on status of the digital imaging device in response to an input control.

5. The digital imaging device of claim 4, wherein the input control comprises a power button.

6. The digital imaging device of claim 4, wherein the input control comprises a control element other than a power button.

7. The digital imaging device of claim 4, wherein the input control comprises a timer.

8. A method for controlling the operation of a digital imaging device, comprising:
activating a power saving mode in the digital imaging device; and
toggling the power-on status of the digital imaging device without retracting a lens of the digital imaging device, when the lens is in an extended position.

9. The method of claim 8, wherein activating the power saving mode in the digital imaging device comprises setting a menu option in the digital imaging device.

10. The method of claim 8, wherein activating the power saving mode in the digital imaging device comprises pressing and holding for a predetermined period a power button on the digital imaging device.

11. The method of claim 8, wherein activating the power saving mode in the digital imaging device comprises receiving a signal from a timer after a predetermined period has elapsed since the digital imaging device was turned on.

12. The method of claim 8, wherein toggling the power-on status of the digital imaging device is performed in response to an input command.

13. The method of claim 12, wherein the input command comprises pressing a power button on the digital imaging device.

14. The method of claim 12, wherein the input command comprises activating a control element other than a power button.

15. The method of claim 8, further comprising closing an automatic lens cover.

16. The method of claim 8, further comprising retracting the lens after a predetermined period has elapsed.

17. A method for controlling the operation of a digital imaging device, comprising:
starting up the digital imaging device and extending a retractable lens in response to a first input command;
activating a power saving mode in the digital imaging device;
shutting down the digital imaging device in response to a second input command, the retractable lens remaining extended.

18. The method of claim 17, further comprising:
starting up the digital imaging device with the retractable lens extended in response to a third input command.

19. The method of claim 17, further comprising closing an automatic lens cover.

20. The method of claim 17, farther comprising retracting the retractable lens after a predetermined period has elapsed.

21. A digital imaging device, comprising:
optical means having an extended position and a retracted position;
means for toggling the power-on status of the digital imaging device without retracting the optical means, when the optical means is in the extended position.

22. The digital imaging device of claim 21, wherein the digital imaging device comprises a digital still camera.

23. The digital imaging device of claim 21, wherein the digital imaging device comprises a digital camcorder.

24. The digital imaging device of claim 21, wherein the means for toggling the power-on status of the digital imaging device is configured to operate in response to a control means.

25. The digital imaging device of claim 24, wherein the control means comprises a power button.

26. The digital imaging device of claim 24, wherein the control means comprises a control element other than a power button.
